(19) United States
(12) Patent Application Publication
(10) Pub. No.: US 2013/0187840 A1
(43) Pub. Date: Jul. 25, 2013

(54) DISPLAY APPARATUS

(71) Applicant: Canon Kabushiki Kaisha, Tokyo (JP)

(72) Inventors: Taiji Tomita, Chiba-shi (JP); Yuushi Ichinose, Yokohama-shi (JP)

(73) Assignee: CANON KABUSHIKI KAISHA, Tokyo (JP)

(21) Appl. No.: 13/687,840

(22) Filed: Nov. 28, 2012

(30) Foreign Application Priority Data
Jan. 24, 2012 (JP) 2012-011947
Nov. 1, 2012 (JP) 2012-241716

(51) Int. Cl. G09G 3/32

(52) U.S. Cl. CPC G09G 3/3208
USPC 345/76

(57) ABSTRACT

Provided is a display apparatus including: a substrate; a first organic light emitting element; a second organic light emitting element; a first color filter; and a second color filter in which the first color filter has a refractive index larger than a refractive index of the second color filter; the first color filter and the second color filter are in contact with each other; and in a cross section taken along a direction perpendicular to the substrate, at a part at which the first color filter and the second color filter are in contact with each other, the first color filter has an angle between a side surface thereof and the substrate, which is more than 90 degrees, and the second color filter has an angle between a side surface thereof and the substrate, which is less than 90 degrees.

### BACKGROUND OF THE INVENTION

1. Field of the Invention

The present invention relates to a display apparatus, and more particularly, to a display apparatus including organic light emitting elements (organic electroluminescence (EL) elements) and color filters.

2. Description of the Related Art

In recent years, an organic light emitting display apparatus (organic EL display apparatus) using multiple types of organic light emitting elements having different emission colors has attracted attention as a display apparatus replacing a CRT and an LCD used as conventional display apparatuses. The organic light emitting element forming the organic EL display apparatus is an electronic element including multiple organic compound layers including an emission layer arranged between an anode and a cathode. The organic light emitting element is a spontaneous emission apparatus, and hence the display apparatus including the organic light emitting element exhibits excellent performance in terms of contrast and color reproducibility.

By the way, there is an organic EL display apparatus in a form in which, other than a form that uses multiple types of organic light emitting elements having different emission colors, organic light emitting elements to be used have one type of emission color (white etc.). In the organic EL display apparatus using the organic light emitting elements of a single type, a single emission color is emitted, and hence it is impossible to cause the elements to directly emit the three primary colors (blue, green, and red). Therefore, color filters are provided in the light extracting directions, to thereby separate the single-color emission into the three primary colors, that is, realize full-color display.

However, in the display apparatus using the color filters, between the organic light emitting element and the color filter, there is provided an inorganic layer for sealing the organic light emitting element or an interposing layer having a constant thickness, which is made of a resin or the like. Therefore, part of light emitted from the organic light emitting element leaks through adjacent color filters to adjacent pixels. As a result, the brightness becomes imbalanced, and there arises a problem in that color shift occurs particularly at a high viewing angle.

In order to solve the problem of this color shift occurrence, for example, there is proposed a method disclosed in Japanese Patent Application Laid-Open No. 2006-73219. The method disclosed in Japanese Patent Application Laid-Open No. 2006-73219 is a method for solving the problem of color shift at a high viewing angle with use of a thickness of a transparent resin layer provided between an emission portion and the color filter thereabove, and a black matrix provided between the adjacent color filters. In this case, the thickness of the transparent resin layer is adjusted so that light beams do not enter lower end portions of the adjacent color filters. On the other hand, the black matrix is provided for the purpose of preventing color leakage from the adjacent color filters or the color converting films, and fluctuations in the light blocking amount.

However, in the technology disclosed in Japanese Patent Application Laid-Open No. 2006-73219, no particular reference is made with respect to the shape of the color filter. For example, when the pixel pitch is extremely reduced, it becomes difficult to arrange the black matrix between the adjacent color filters, and each of the color filters is formed under a state in which the corresponding color filter is brought into direct and close contact with the adjacent color filters. In such a case, many color filters are formed by photolithography. At this time, the first color filter is generally formed of a negative resist, and the color filter formed of a negative resist tends to have an inverse-tapered sectional shape. Therefore, a color filter formed in the subsequent step adjacently to the previously-formed color filter tends to have a forward-tapered sectional shape. On the other hand, in the case where the first color filter is formed of a positive resist, the formed color filter tends to have a forward-tapered sectional shape. Therefore, a color filter formed in the subsequent step adjacently to the previously-formed color filter tends to have an inverse-tapered sectional shape. As described above, when the color filters are formed by photolithography, tapered (forward-tapered) or inverse-tapered color filters are obtained.

FIG. 3 is a schematic sectional view illustrating an example of a display apparatus including a color filter for each organic light emitting element. A display apparatus 100 of FIG. 3 includes a substrate 120, an organic light emitting element including a first electrode 121, an organic compound layer 122, and a second electrode 123, a protective layer 124, two types of color filters, and a color filter protective layer 125. The two types of color filters are a first color filter 112a and a second color filter 112b. In the display apparatus 100 of FIG. 3, the first color filter 112a has a cross section in a direction perpendicular to the substrate 120 in an inverse-tapered shape (shape in which an upper surface region of the first color filter 112a on the observer's side is wider than a bottom surface region thereof on the pixel surface side). The second color filter 112b has a cross section in that direction in a forward-tapered shape (shape in which a bottom surface region of the second color filter 112b on the pixel surface side is wider than an upper surface region thereof on the observer's side). Further, in the display apparatus 100 of FIG. 3, the first color filter 112a and the second color filter 112b are provided in a close-contact state to each other. Still further, in the display apparatus 100 of FIG. 3, the two types of color filters (112a and 112b) are formed in such a manner that the first color filter 112a is first formed with use of a negative resist, and the second color filter 112b is successively formed.

In a second pixel 110b including the second color filter 112b having a forward-tapered sectional shape, in light (hν_{b}) emitted from an organic light emitting element 111b included in the second pixel 110b, regarding an oblique direction, a light amount passing through the first color filter 112a is larger than a light amount passing through the second color filter 112b. In this case, unnecessary light that is supposed to be absorbed by the second color filter 112b is not sufficiently absorbed, and hence mixed color light is emitted, in which a color other than a color of light passing through the second color filter 112b is mixed. In this case, when the display apparatus is viewed from the oblique direction, color shift is observed.

As described above, in the conventional display apparatus, color shift has been a problem in a pixel including a forward-tapered color filter.

### SUMMARY OF THE INVENTION

The present invention has been made to solve the above-mentioned problem, and therefore has an object to provide a display apparatus in which color shift at a high viewing angle is suppressed.

According to an exemplary embodiment of the present invention, there is provided a display apparatus, including: a substrate; a first organic light emitting element; a second organic light emitting element; a first color filter provided in a region corresponding to the first organic light emitting element; and a second color filter provided in a region corresponding to the second organic light emitting element, for transmitting a color different from a color transmitted by the first color filter. The first color filter has a refractive index larger than a refractive index of the second color filter. The first color filter and the second color filter are in contact with each other. In a cross section taken along a direction perpendicular to the substrate, at a part at which the first color filter and the second color filter are in contact with each other, the first color filter has an angle between a side surface thereof and the substrate, which is more than 90 degrees, and the second color filter has an angle between a side surface thereof and the substrate, which is less than 90 degrees.

According to the present invention, it is possible to provide the display apparatus in which the color shift in an oblique direction is suppressed.

That is, in the display apparatus of the present invention, the pixel including the color filter having a forward-tapered sectional shape in a direction perpendicular to the substrate has a high possibility of color mixture. However, in light emitted from this pixel, light passing through a color filter included in an adjacent pixel is refracted on the low angle side. Therefore, color shift in the oblique direction is suppressed. On the other hand, light emitted from the pixel including the color filter having an inverse-tapered sectional shape is refracted on the high angle side when the light enters from the inverse-tapered color filter into the adjacent forward-tapered color filter. Further, total reflection occurs when light is refracted on the high angle side. Therefore, color mixture hardly occurs, and there is no problem of color shift at a high viewing angle. As a result, the problem of color shift at a high viewing angle in the whole display apparatus can be solved.

Further features of the present invention will become apparent from the following description of exemplary embodiments with reference to the attached drawings.

### BRIEF DESCRIPTION OF THE DRAWINGS

FIG. 1 is a schematic sectional view illustrating a display apparatus according to a first embodiment of the present invention.

FIG. 2 is a schematic sectional view illustrating a display apparatus according to a second embodiment of the present invention.

FIG. 3 is a schematic sectional view illustrating an example of a display apparatus including a color filter for each organic light emitting element.

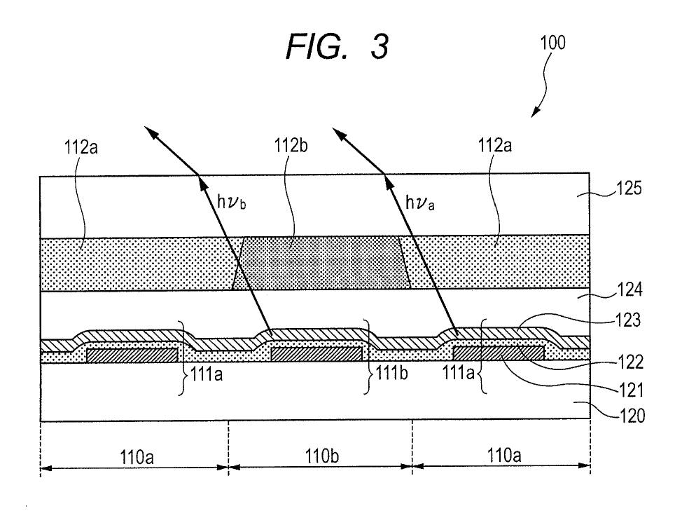

### DESCRIPTION OF THE EMBODIMENTS

A display apparatus of the present invention includes a substrate, and a first pixel and a second pixel provided on the substrate. That is, the display apparatus of the present invention includes at least two types of pixels. Note that, the number of types of the pixels included in the display apparatus of the present invention is not limited to two.

In the display apparatus of the present invention, the first pixel and the second pixel each includes an organic light emitting element, and a color filter provided in a region corresponding to an emission region of the organic light emitting element. The organic light emitting element included in the pixel in this case includes a first electrode provided on the substrate, an organic compound layer including an emission layer, and a second electrode. Further, a protective layer is provided between the organic light emitting element and the color filter in order to prevent moisture and oxygen from entering the organic light emitting element from outside.

Further, in the display apparatus of the present invention, a part of the region in which the organic light emitting element is provided is an emission region, and the color filter is provided in a planar region on the protective layer, which corresponds to the emission region.

In the present invention, the color filter included in each pixel has the following features. First, the color of the color filter included in each pixel differs depending on the type of the pixel. In a case where the number of types of pixels is two (first pixel and second pixel), the color filter of the first pixel and the color filter of the second pixel have different colors. Further, in a case where the number of types of pixels is three (first pixel, second pixel, and third pixel), the color filter of the first pixel, the color filter of the second pixel, and the color filter of the third pixel have different colors.

In the present invention, the refractive index of the first color filter included in the first pixel is larger than the refractive index of the second color filter included in the second pixel. Further, the first color filter and the second color filter are in direct (physical) contact with each other. Still further, in a cross section of a contact plane between the first color filter and the second color filter in a direction perpendicular to the substrate, the first color filter includes an inverse-tapered portion, and the second color filter includes a tapered portion.

In other words, in the present invention, in a cross section of a contact plane between two color filters taken along a direction perpendicular to a substrate, a color filter having a relatively higher refractive index includes an inverse-tapered portion, and a color filter having a relatively lower refractive index includes a tapered portion. The tapered (forward-tapered) portion refers to a portion having such a shape that, in the above-mentioned cross section, an angle between a side surface of the color filter and the substrate is less than 90 degrees. On the other hand, the inverse-tapered portion refers to a portion having such a shape that, in the above-mentioned cross section, an angle between a side surface of the color filter and the substrate is more than 90 degrees.

In the following, embodiments of the present invention are described referring to the accompanying drawings. However, the present invention is not limited to the following embodiments. To a part which is not particularly illustrated in the figures or described below, known or common technologies in the technical field can be applied.

### First Embodiment

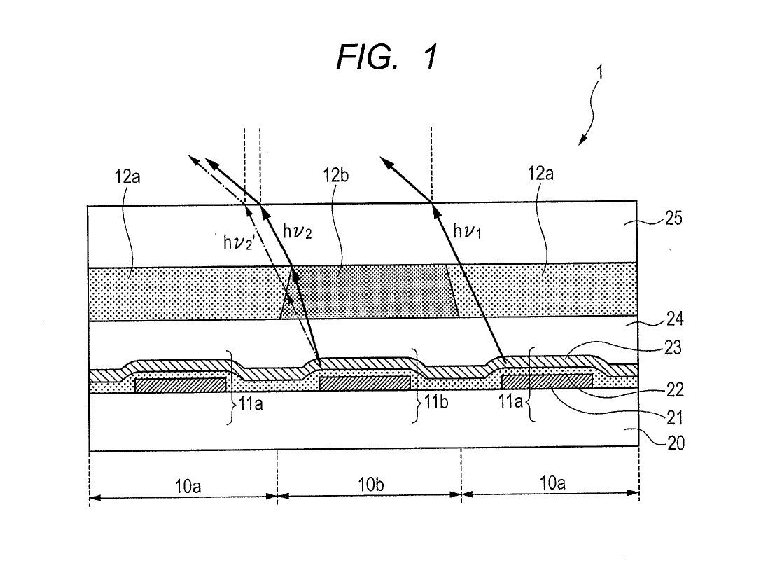

FIG. 1 is a schematic sectional view illustrating a display apparatus according to a first embodiment of the present invention. A display apparatus 1 of FIG. 1 includes a substrate 20, and adjacent two types of pixels provided on the substrate 20, that is, a first pixel 10a and a second pixel 10b. Further, the two types of pixels (10a and 10b) are brought into close contact with each other and are alternately arranged. Note that, the two types of pixels (10a and 10b) included in the display apparatus 1 of FIG. 1 are arranged in matrix (not shown) when the display apparatus is viewed from a planar side. Further, the display apparatus 1 of FIG. 1 is a top-emission type display apparatus in which light is extracted from the upper surface side (side opposite to the substrate 20) of organic light emitting elements (11a and 11b) formed on the substrate 20.

In the display apparatus 1 of FIG. 1, the first pixel 10a includes the organic light emitting element (first organic light emitting element 11a) and a first color filter 12a. On the other hand, the second pixel 10b includes the organic light emitting element (second organic light emitting element 11b) and a second color filter 12b. In the present invention, the pixels (10a and 10b) are each provided with one organic light emitting element. The color of light emitted by each of the pixels (10a and 10b) is not particularly limited, but because the types are different, the display apparatus 1 of FIG. 1 can emit two types of light.

Further, a part of a region (planar region) in which each of the two types of organic light emitting elements (11a and 11b) forming the display apparatus 1 of FIG. 1 is provided is an emission region. Specifically, in a region in which each of the organic light emitting elements (11a and 11b) is provided, a planar region of a first electrode 21 that is a component of each of the organic light emitting elements (11a and 11b) corresponds to the emission region.

Next, the components of the display apparatus 1 of FIG. 1 are described.

The substrate 20 includes a base member (not shown), and a pixel circuit (not shown) provided on the base member and enabling independent driving of each of the organic light emitting elements (11a and 11b). In this case, the pixel circuit provided in the substrate 20 includes multiple transistors (not shown). Further, on the substrate 20, there are provided an interlayer insulating film (not shown) provided between the transistor and the first electrode 21, and a contact hole for electrically connecting the transistor and the first electrode 21. The base member may be made of glass, plastic, a metal, and the like. Further, the base member may be transparent or opaque.

Each of the organic light emitting elements (11a and 11b) is an electric element formed by laminating the first electrode 21 provided on the substrate 20, an organic compound layer 22, and a second electrode 23 in the stated order.

When the first electrode 21 forming each of the organic light emitting elements (11a and 11b) is an anode electrode, as a material for forming the first electrode 21, a conductive metal material such as Ag, Al, and Ti may be used. Further, when the first electrode 21 is the anode electrode, the first electrode 21 may be formed of a laminate including a layer made of the above-mentioned conductive metal material and a layer made of a transparent conductive material such as indium-tin-oxide (ITO) excellent in hole injection properties.

As the distance between the first electrodes 21 becomes larger, in light emitted from a pixel including a color filter having a forward-tapered sectional shape, light passing through an adjacent pixel has a smaller angle with respect to the substrate. Therefore, color shift in an oblique direction is suppressed. However, when the distance between the first electrodes 21 increases, the area of the first electrode 21 decreases, and the life of the organic light emitting element is shortened. Alternatively, there occurs such an adverse effect that power consumption of the organic light emitting element increases. Further, this adverse effect becomes conspicuous as the resolution becomes higher. Therefore, the distance between the first electrodes 21 is preferred to be about 1 μm to 3 μm.

The distance between the electrodes referred to herein means a distance between the two types of pixels (10a and 10b) in a region in which no light beams are substantially emitted from the organic light emitting elements. For example, in a case where a bank or the like is present between the anode electrodes so as to cover the anode electrodes, the distance between the electrodes means a distance between end portions of the electrode surfaces not covered with the bank or the like.

The organic compound layer 22 forming each of the organic light emitting elements (11a and 11b) is a single layer or a laminate formed of multiple layers including at least an emission layer. In a case where the organic compound layer 22 is a laminate formed of multiple layers, as a specific layer configuration, for example, the configurations described in the following items (i) and (ii) can be exemplified. Note that, in the present invention, the configuration of the organic compound layer is not limited to those in the following items (i) and (ii).

(i) hole transport layer/emission layer/electron transport layer/electron injection layer

(ii) hole transport layer/emission layer/electron transport layer

As a material for forming the organic compound layer 22 (organic light emitting material, charge transport material, and charge injection material), a known material can be used.

Note that, the organic compound layer 22 forming the display apparatus 1 of FIG. 1 is formed as a layer shared by the respective pixels (10a and 10b), but the present invention is not limited to this configuration.

When the first electrode 21 is the anode electrode, the second electrode 23 forming each of the organic light emitting elements (11a and 11b) functions as a cathode electrode. Note that, the second electrode 23 forming the display apparatus 1 of FIG. 1 is formed as a layer shared by the respective pixels (10a and 10b), but the present invention is not limited to this configuration. Further, as described above, in the case where the display apparatus 1 of FIG. 1 is a top-emission type display apparatus, the second electrode 23 is an electrode having a semi-reflective property or a light-transmitting property, which allows the light emitted from the emission layer (not shown) forming the organic compound layer 22 to be extracted to the outside of the element. The term “semi-reflective property” means a property of reflecting a part of the light emitted from the inside of the element and transmitting the other part of the emitted light, and specifically, has a reflectance of 20 to 80% with respect to visible light. The term “light-transmitting property” means a property with a transmission rate of 80% or higher with respect to the visible light.

In a case where the second electrode 23 is formed as an electrode having a semi-reflective property for the purpose of enhancing an interference effect inside the element, the second electrode 23 is formed as an electrode thin film made of a conductive metal material excellent in an electron injection property, specifically, Ag, AgMg, or the like, to have a thickness in a range of 2 nm or more and 50 nm or less.

In the display apparatus 1 of FIG. 1, on the second electrode 23, there is formed a protective layer 24 for protecting the organic light emitting elements from oxygen and moisture in air. The protective layer 24 can be formed by, for example, depositing silicon nitride by plasma CVD. As the thickness of the protective layer 24 is smaller, in light emitted from the pixel including the color filter having a forward-tapered sectional shape, light passing through the adjacent pixel has a smaller angle with respect to the substrate. Thus, the color shift in the oblique direction is suppressed, but considering protection from oxygen and moisture in air, the thickness is preferred to be 2 μm or more and 4 μm or less.

In the display apparatus 1 of FIG. 1, the color filters are provided on the protective layer 24. Specifically, the first color filter 12a is provided in the region corresponding to the first pixel 10a, and the second color filter 12b is provided in the region corresponding to the second pixel 10b.

In the display apparatus 1 of FIG. 1, the first color filter 12a has a cross section in a direction perpendicular to the substrate in an inverse-tapered shape, while the second color filter 12b has a cross section in that direction in a forward-tapered shape. Further, in the display apparatus 1 of FIG. 1, the first color filter 12a and the second color filter 12b are in direct (physical) contact with each other. Therefore, in the cross section in the direction perpendicular to the substrate 20, an angle between a side surface of the first color filter 12a and the substrate 20 is larger than 90 degrees, while an angle between a side surface of the second color filter 12b and the substrate 20 is less than 90 degrees. Further, each of the color filters (12a and 12b) has a stripe planar shape.

In the present invention, the refractive index of the first color filter 12a forming the display apparatus 1 of FIG. 1 is larger than the refractive index of the second color filter 12b. In the following, as a specific example of the display apparatus 1 of FIG. 1, actions and effects generated by the magnitude relationship of the refractive indexes of the two types of color filters are described.

FIG. 1 illustrates trajectories of a light beam (hν₁) emitted from the first organic light emitting element 11a included in the first pixel 10a and a light beam (hν₂) emitted from the second organic light emitting element 11b included in the second pixel 10b. Note that, the two types of light beams (hν₁ and hν₂) are also illustrated to describe what kind of trajectory the light exiting outside the display apparatus at a certain angle (for example, maximum viewing angle necessary for an optical apparatus such as a display) passes through each of the color filters (12a and 12b).

In this case, the first color filter 12a has an inverse-tapered sectional shape, and hence most part of the light beam (hν₁) emitted from the first organic light emitting element 11a in a range of a necessary viewing angle passes through only the first color filter 12a. Even if a part of the light beam (hν₁) reaches an interface between the first color filter 12a and the second color filter 12b, total reflection occurs at the interface in most cases due to the incident angle of light to the interface and the refractive index difference between both the color filters (12a and 12b). Therefore, light hardly travels inside the adjacent second color filter 12b.

On the other hand, the second color filter 12b has a forward-tapered sectional shape, and hence a part of the light beam (for example, light beam hν₂′ in FIG. 1) emitted from the second organic light emitting element 11b may pass through the interface between the second color filter 12b and the first color filter 12a. However, the light that has reached the interface is refracted toward the first color filter 12a adjacent to the second color filter 12b due to the refractive index difference between both the color filters (12a and 12b). With this refraction, when the light that has reached the interface between both the color filters (12a and 12b) exits from a color filter protective layer 25, the exiting angle thereof deviates from the range of the above-mentioned necessary viewing angle. Therefore, a part of the light beam emitted from the second organic light emitting element 11b in the range of the above-mentioned necessary viewing angle is limited to light exiting from the upper surface or from the vicinity of the upper end portion of the second color filter 12b (for example, hν₂ in FIG. 1). In this case, the light exiting from the upper surface of the second color filter 12b is light passing through only the second color filter 12b, and hence there is no problem of color shift in this light. On the other hand, the light (hν₂) exiting from the vicinity of the upper end portion of the second color filter 12b may have slightly passed through the first color filter 12a, but the distance that the light beam passes inside the second color filter 12b is large, and hence the color shift generated thereby is small.

As described above, in the present invention, a specific refractive index difference is provided between both the color filters (12a and 12b), and thus the problem of color shift at a high viewing angle, which has conventionally been a problem, can be reduced.

In the present invention, each of the color filters (12a and 12b) is made of a material obtained by, for example, mixing a pigment into a resin material or the like, and can be sequentially formed into a desired shape by photolithography. When the color filter is formed of a negative resist, an inverse-tapered color filter is formed, which has an inverse-taper angle of 100 degrees or more and 120 degrees or less. On the other hand, when the color filter is formed after the inverse-tapered color filter is formed, a forward-tapered color filter is formed, which has a forward-taper angle of 60 degrees or more and 80 degrees or less.

Further, the thickness of each color filter is adjusted as appropriate so that the front chromaticity becomes a desired chromaticity. For example, the thickness in this embodiment is 2 μm.

The refractive index of each color filter is preferred to be 1.4 or more and 2.0 or less. Further, in a configuration in which the above-mentioned forward-taper angle is 60 degrees or more and 80 degrees or less (inverse-taper angle is 100 degrees or more and 120 degrees or less), the ratio of the refractive index of the color filter having the relatively higher refractive index with respect to the refractive index of the color filter having the relatively lower refractive index is preferably 1.001 or more and 1.300 or less, more preferably 1.010 or more and 1.300 or less, further preferably 1.050 or more and 1.300 or less. As the ratio of the refractive index becomes larger, the effect of the present invention becomes larger, but the refractive index of the color filter has a limitation to some extent depending on its material and the like, and hence the refractive index ratio substantially has a limitation of about 1.300.

Note that, the refractive index of each of the color filters (12a and 12b) can be easily changed by mainly changing a material to become a binder of the color filter. For example, in the case of a color filter having a high refractive index, a polyimide resin material or a novolac resin material may be used as a binder, and its refractive index is about 1.6 to 2.0. On the other hand, in the case of a color filter having a low refractive index, an acrylic resin material may be used as a binder, and its refractive index is about 1.4 to 1.8.

On the respective color filters (12a and 12b), the color filter protective layer 25 is formed for the purpose of protecting the respective color filters (12a and 12b). The color filter protective layer 25 can be formed by forming a thermosetting resin film and heating the film.

### Second Embodiment

The embodiment (first embodiment) described above is a system in which the number of types of color filters is two, but the number of types of color filters in the present invention is not limited to two, and the present invention can be easily applied even when the number is three or more. Further, the material, thickness, and the like in a second embodiment of the present invention, which are not particularly specified, are equivalent to those in the first embodiment.

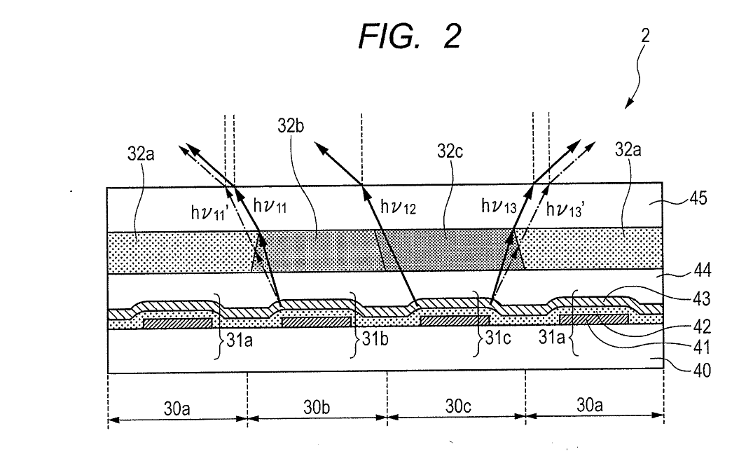

FIG. 2 is a schematic sectional view illustrating a display apparatus according to the second embodiment of the present invention. A display apparatus 2 of FIG. 2 includes, on a substrate 40, three types of pixels, that is, a first pixel 30a, a second pixel 30b, and a third pixel 30c. The first pixel 30a includes an organic light emitting element (first organic light emitting element 31a) and a first color filter 32a. The second pixel 30b includes an organic light emitting element (second organic light emitting element 31b) and a second color filter 32b. The third pixel 30c includes an organic light emitting element (third organic light emitting element 31c) and a third color filter 32c. Note that, each of the organic light emitting elements includes a first electrode 41, an organic compound layer 42, and a second electrode 43. Further, in the display apparatus 2, there is formed a protective layer 44 between each organic light emitting element and each color filter in order to prevent moisture and oxygen from entering the organic light emitting element from outside. The protective layer 44 is shared by the respective pixels. Further, on the respective color filters, a color filter protective layer 45 is formed so as to be shared by the respective color filters. The three types of color filters transmit light of different colors. Specifically, the three types of color filters (32a, 32b, and 32c) are color filters which transmit light of blue, green, and red, respectively. Note that, in the present invention, the combination of colors of light that the color filters (32a, 32b, and 32c) transmit is not particularly limited. Further, the organic compound layer 42 emits white light.

In the display apparatus 2 of FIG. 2, the first color filter 32a has an inverse-tapered sectional shape, and the second color filter 32b has a forward-tapered sectional shape. Further, the third color filter 32c arranged between the first color filter 32a and the second color filter 32b has a cross section formed into a trapezoidal shape or a parallelogram shape having a taper and an inverse-taper by the sectional shapes of the adjacent color filters (32a and 32b).

The first color filter 32a is in direct (physical) contact with the second color filter 32b and the third color filter 32c. The second color filter 32b is in direct (physical) contact with the third color filter 32c and the first color filter 32a. The third color filter 32c is in direct (physical) contact with the first color filter 32a and the second color filter 32b.

In the display apparatus 2 of FIG. 2, the refractive index is larger in the descending order of the first color filter 32a, the third color filter 32c, and the second color filter 32b. With this, effects similar to those of the first embodiment can be obtained.

Similarly to the first embodiment, in a cross section of a contact plane between two color filters taken along a direction perpendicular to a substrate, a color filter having a relatively higher refractive index includes an inverse-tapered portion, and a color filter having a relatively lower refractive index includes a tapered portion. Specifically, in the cross section in the direction perpendicular to the substrate 40, at a part at which the first color filter 32a and the second color filter 32b are in contact with each other, an angle between a side surface of the first color filter 32a and the substrate 40 is more than 90 degrees, and an angle between a side surface of the second color filter 32b and the substrate 40 is less than 90 degrees. At a part at which the second color filter 32b and the third color filter 32c are in contact with each other, an angle between a side surface of the third color filter 32c and the substrate 40 is more than 90 degrees, and an angle between the side surface of the second color filter 32b and the substrate 40 is less than 90 degrees. At a part at which the first color filter 32a and the third color filter 32c are in contact with each other, an angle between the side surface of the first color filter 32a and the substrate 40 is more than 90 degrees, and an angle between the side surface of the third color filter 32c and the substrate 40 is less than 90 degrees.

First, light emitted from the second organic light emitting element 31b forming the second pixel 30b is described. The second color filter 32b included in the second pixel 30b has a forward-tapered sectional shape similarly to the second color filter 12b forming the display apparatus of FIG. 1. Therefore, the third color filter 12c produces similar actions and effects as the second color filter 12b forming the display apparatus of FIG. 1. That is, a part of the light beam emitted from the second organic light emitting element 31b in the range of the above-mentioned necessary viewing angle is limited to light exiting from the upper surface or from the vicinity of the upper end portion of the second color filter 32b (for example, hν₁₁ in FIG. 2). With this, the problem of color shift at a high viewing angle is solved.

Next, light emitted from the third organic light emitting element 31c forming the third pixel 30c is described. In the display apparatus 2 of FIG. 2, the third color filter 32c includes an inverse-tapered portion on a side on which the third color filter 32c and the second color filter 32b are in contact with each other. Further, the refractive index of the third color filter 32c is larger than that of the second color filter 32b, and hence, in light emitted from the third organic light emitting element 31c, most part of a light beam (hν₁₂) traveling toward the second pixel 30b passes through only the third color filter 32c.

On the other hand, the third color filter 32c includes a forward-tapered portion on a side on which the third color filter 32c and the first color filter 32a are in contact with each other, and the refractive index of the third color filter 32c is smaller than that of the first color filter 32a. In this case, in the light emitted from the third organic light emitting element 31c, a part of the light beam traveling toward the first pixel 30a (for example, hν₁₃′ in FIG. 2) may pass through an interface between the third color filter 32c and the first color filter 32a. However, the light that has reached this interface is refracted toward the first color filter 32a adjacent to the third color filter 32c due to the refractive index difference between both the color filters (32a and 32c). With this refraction, when the light that has reached the interface between both the color filters (32a and 32c) exits from the color filter protective layer 45, the exiting angle thereof deviates from the range of the necessary viewing angle. Therefore, a part (hν₁₃) of the light beam emitted from the third organic light emitting element 31c in the range of the necessary viewing angle is limited to light exiting from the upper surface or from the vicinity of the upper end portion of the third color filter 32c.

Regarding both of the light beams hν₁₂ and hν₁₃, most part of the light emitted from the third pixel 30c in the range of the necessary viewing angle passes through only the third color filter 32c, and hence the problem of color shift at a high viewing angle is solved.

By the way, as described above, when the color filter is formed of a negative resist by photolithography, the color filter formed first tends to have an inverse-tapered sectional shape. Considering this point, the color filters (32a, 32b, and 32c) forming the display apparatus 2 of FIG. 2 are preferred to be formed in the order of the first color filter 32a, the third color filter 32c, and the second color filter 32b.

Also in this case, an inverse-tapered color filter is formed, which has an inverse-taper angle of 100 degrees or more and 120 degrees or less. On the other hand, when the color filter is formed after the inverse-tapered color filter is formed, a forward-tapered color filter is formed, which has a forward-taper angle of 60 degrees or more and 80 degrees or less.

Further, the thickness of each color filter is adjusted as appropriate so that the front chromaticity becomes a desired chromaticity. For example, the thickness in this embodiment is 2 μm.

The refractive index of each color filter is preferred to be 1.4 or more and 2.0 or less. Further, similarly to the first embodiment, the ratio of the refractive index of the first color filter with respect to the refractive index of the second color filter is preferably 1.001 or more and 1.300 or less, more preferably 1.010 or more and 1.300 or less, further preferably 1.050 or more and 1.300 or less. Further, the ratio of the refractive index of the third color filter with respect to the refractive index of the second color filter is preferably 1.001 or more and 1.150 or less, more preferably 1.010 or more and 1.150 or less, further preferably 1.050 or more and 1.150 or less. As the ratio of the refractive index becomes larger, the effect of the present invention becomes larger, but the refractive index of the color filter has a limitation to some extent depending on its material and the like, and hence, in order to obtain the same effects in the respective pixels when the three types of color filters are provided, the refractive index ratio has a limitation of about 1.150. Further, the ratio of the refractive index of the first color filter with respect to the refractive index of the third color filter is preferably 1.001 or more and 1.150 or less, more preferably 1.010 or more and 1.150 or less, further preferably 1.050 or more and 1.150 or less.

The present invention is not limited to the embodiments described above as long as the present invention does not depart from the above-mentioned gist, and various applications and modifications may be made thereto.

### Example 1

The display apparatus 1 illustrated in FIG. 1 was manufactured by the following method. Note that, pitches of respective pixels included in the display apparatus manufactured in this example were set to 12 μm×6 μm.

(1) Step of Manufacturing Substrate Provided with First Electrode

On a silicon substrate, a pixel circuit (not shown) including TFTs was formed, and then an interlayer insulating film made of SiO was formed on the pixel circuit, to thereby manufacture the substrate 20. Next, a Ti film was formed on the substrate 20 by sputtering. As this time, the thickness of the Ti film was set to 50 nm. Next, the Ti film was patterned for each pixel to form an anode electrode (first electrode 21). At this time, the size of the exposed part of the first electrode 21 was set to 9 μm×4 μm. In this case, the distance between the first electrodes 21 is 2 μm. Next, the substrate 20 having the first electrode 21 formed thereon was subjected to ultrasonic cleaning with isopropyl alcohol (IPA), followed by boiling cleaning and drying. Further, UV/ozone cleaning was performed.

(2) Step of Forming Organic Compound Layer

Next, the organic compound layer 22 was formed on at least the first electrode 21 by vapor deposition. A specific method is described below.

First, a hole transport layer having a thickness of 87 nm was formed as a layer shared by all the pixels. At the time when the hole transport layer was formed, the degree of vacuum was set to 1×10⁻⁴ Pa, and the deposition rate was set to 0.2 nm/sec.

Next, with use of a shadow mask having an opening in a region corresponding to the exposed part of the first electrode 21, a white-color emission layer having a thickness of 30 nm was formed on the hole transport layer in the region corresponding to the exposed part of the first electrode 21.

Next, on the white-color emission layer or the hole transport layer, a bathophenanthroline (Bphen) film was formed as the electron transport layer. At this time, the conditions were set as follows. The thickness of the electron transport layer was set to 10 nm, the degree of vacuum at the time of deposition was set to 1×10⁻⁴ Pa, and the film formation rate was set to 0.2 nm/sec. Further, the electron transport layer was formed as a layer shared by all the pixels.

Next, on the electron transport layer, Bphen and Cs₂CO₃ were co-evaporated (weight ratio; Bphen:Cs₂CO₃=90:10) to form the electron injection layer. At this time, the conditions were set as follows. The thickness of the electron injection layer was set to 40 nm, the degree of vacuum at the time of deposition was set to 3×10⁻⁴ Pa, and the film formation rate was set to 0.2 nm/sec. Further, the electron injection layer was formed as a layer shared by all the pixels.

(3) Step of Forming Second Electrode

Next, the substrate having the organic compound layer 22 formed thereon was moved into a sputtering apparatus without breaking the vacuum state. Next, on the electron injection layer, a transparent electrode thin film made of a mixture containing indium oxide and zinc oxide was formed by sputtering to form the cathode electrode (second electrode 23). At this time, the thickness of the second electrode 23 was set to 100 nm.

(4) Step of Forming Protective Layer

Next, the protective layer 24 made of silicon nitride was formed on the second electrode 23 by plasma CVD using an SiH₄ gas, an N₂ gas, and an H₂ gas. At this time, the thickness of the protective layer 24 was set to 2 μm. Note that, the refractive index of the protective layer 24 was 1.96.

(5) Step of Forming Color Filter

Next, a green pigment and a polyimide-based material as a matrix were mixed together with a solvent to prepare a green color filter material. Next, the green color filter material was applied on the protective layer 24 by a spin coater to form a thin film. The thickness of the thin film formed at this time was 2 μm. Next, with use of a stripe-shaped photomask having a pitch of 12 μm and a width of 6 μm, exposure and development were performed to process the thin film. Thus, the first color filter 12a having an inverse-tapered sectional shape was formed. At this time, the refractive index of the first color filter 12a was 1.7, and the taper angle with respect to the surface of the protective layer 24 was 110°.

Next, a red pigment and an acrylic-based material as a matrix were mixed together with a solvent to prepare a red color filter material. Next, the red color filter material was applied on at least the protective layer 24 by a spin coater to form a thin film. The thickness of the thin film formed at this time was 2 μm. Next, with use of a stripe-shaped photomask having a pitch of 12 μm and a width of 6 μm, exposure and development were performed to process the thin film. Thus, the second color filter 12b having a forward-tapered sectional shape was formed. At this time, the refractive index of the second color filter 12b was 1.5, and the taper angle with respect to the surface of the protective layer 24 was 70°. That is, in this example, the taper angle of adjacent surfaces of the adjacent color filters (12a and 12b) was 70° with respect to the horizontal direction.

(6) Step of Forming Color Filter Protective Layer

Next, on the color filters (12a and 12b), a thermosetting resin having a viscosity of 200 cp and a refractive index of 1.5 was applied by a spin coater to form a thin film. Next, with use of a hot plate, the thin film was heated at 120° C. for 10 minutes to be cured, and thus the color filter protective layer 25 was formed. At this time, the thickness of the color filter protective layer 25 was 5 μm. With the above-mentioned steps, the display apparatus 1 of FIG. 1 was manufactured.

Note that, in the manufacturing process described above, the first color filter 12a is the green color filter and the second color filter 12b is the red color filter, but the present invention is not limited thereto. In other words, in the present invention, in theory, six combinations can be considered for the first color filter 12a and the second color filter 12b as shown in Table 1 below.

TABLE 1

| | First color filter | Second color filter |
|---|---|---|
| Type 1 | Green | Red |
| Type 2 | Blue | Red |
| Type 3 | Red | Green |
| Type 4 | Blue | Green |
| Type 5 | Red | Blue |
| Type 6 | Green | Blue |

In this example, the pigments to be used were selected as appropriate, and display apparatuses respectively corresponding to the six types as shown in Table 1 were manufactured.

### Comparative Example 1

A display apparatus was manufactured by a method similar to that in Example 1 except that the matrix of the first color filter in Example 1 was changed to an acrylic-based material.

(Evaluation of Display Apparatus)

Regarding the manufactured display apparatuses, the chromaticity on the front side (front chromaticity) and the chromaticity at 30° from the front side (30° chromaticity) were measured. Note that, measurement at a position of 30° from the front side is performed in consideration of relatively-small applications requiring a small necessary viewing angle, such as an EVF for a digital camera. Results are shown in Tables 2 to 7. Note that, Tables 2 to 7 each show coordinates (CIExy chromaticity coordinate system, U′V′ coordinate system) of chromaticity of light measured from each of the front side and at a position of 30° from the front side and a chromaticity change (ΔU′V′: distance in U′V′ coordinates) when moved from the front side to the position of 30° from the front side.

TABLE 2

| | Type 1 | | | | | |
|---|---|---|---|---|---|---|
| | First color filter | | | Second color filter | | |
| | Polyimide, Green | | | Acrylic, Red | | |
| | | Front | 30° | | Front | 30° |
| | | chromaticity | chromaticity | | chromaticity | chromaticity |
| Example 1 | CIE(x, y) | 0.25, 0.62 | 0.25, 0.62 | CIE(x, y) | 0.65, 0.33 | 0.66, 0.33 |
| | U′, V′ | 0.1, 0.56 | 0.10, 0.56 | U′, V′ | 0.46, 0.52 | 0.47, 0.52 |
| | ΔU′V′ with respect to | | 0.002 | ΔU′V′ with respect to | | 0.005 |
| | front side | | | front side | | |
| | Acrylic, Green | | | Acrylic, Red | | |
| | | Front | 30° | | Front | 30° |
| | | chromaticity | chromaticity | | chromaticity | chromaticity |
| Comparative | CIE(x, y) | 0.25, 0.62 | 0.25, 0.62 | CIE(x, y) | 0.65, 0.33 | 0.52, 0.39 |
| Example 1 | U′, V′ | 0.1, 0.56 | 0.10, 0.56 | U′, V′ | 0.46, 0.52 | 0.31, 0.53 |

| | | | |
|---|---|---|---|
| ΔU′V′ with respect to | 0.002 | ΔU′V′ with respect to | 0.151 |
| front side | | front side | |

TABLE 3

| | Type 2 | | | | | |
|---|---|---|---|---|---|---|
| | First color filter | | | Second color filter | | |
| | Polyimide, Blue | | | Acrylic, Red | | |
| | | Front | 30° | | Front | 30° |
| | | chromaticity | chromaticity | | chromaticity | chromaticity |
| Example 1 | CIE(x, y) | 0.13, 0.14 | 0.13, 0.14 | CIE(x, y) | 0.65, 0.33 | 0.66, 0.33 |
| | U′, V′ | 0.11, 0.29 | 0.12, 0.28 | U′, V′ | 0.46, 0.52 | 0.47, 0.52 |
| | ΔU′V′ with respect to | | 0.007 | ΔU′V′ with respect to | | 0.005 |
| | front side | | | front side | | |
| | Acrylic, Blue | | | Acrylic, Red | | |
| | | Front | 30° | | Front | 30° |
| | | chromaticity | chromaticity | | chromaticity | chromaticity |
| Comparative | CIE(x, y) | 0.13, 0.14 | 0.13, 0.14 | CIE(x, y) | 0.65, 0.33 | 0.52, 0.32 |
| Example 1 | U′, V′ | 0.11, 0.29 | 0.12, 0.28 | U′, V′ | 0.46, 0.52 | 0.35, 0.50 |

| | | | |
|---|---|---|---|
| ΔU′V′ with respect to | 0.007 | ΔU′V′ with respect to | 0.113 |
| front side | | front side | |

TABLE 4

| | Type 3 | | | | | |
|---|---|---|---|---|---|---|
| | First color filter | | | Second color filter | | |
| | Polyimide, Red | | | Acrylic, Green | | |
| | | Front | 30° | | Front | 30° |
| | | chromaticity | chromaticity | | chromaticity | chromaticity |
| Example 1 | CIE(x, y) | 0.65, 0.33 | 0.66, 0.33 | CIE(x, y) | 0.25, 0.62 | 0.25, 0.62 |
| | U′, V′ | 0.46, 0.52 | 0.47, 0.52 | U′, V′ | 0.1, 0.56 | 0.10, 0.56 |
| | ΔU′V′ with respect to | | 0.005 | ΔU′V′ with respect to | | 0.002 |
| | front side | | | front side | | |
| | Acrylic, Red | | | Acrylic, Green | | |
| | | Front | 30° | | Front | 30° |
| | | chromaticity | chromaticity | | chromaticity | chromaticity |
| Comparative | CIE(x, y) | 0.65, 0.33 | 0.66, 0.33 | CIE(x, y) | 0.25, 0.62 | 0.31, 0.55 |
| Example 1 | U′, V′ | 0.46, 0.52 | 0.47, 0.52 | U′, V′ | 0.1, 0.56 | 0.14, 0.55 |

| | | | |
|---|---|---|---|
| ΔU′V′ with respect to | 0.005 | ΔU′V′ with respect to | 0.038 |
| front side | | front side | |

TABLE 5

| | Type 4 | | | | | |
|---|---|---|---|---|---|---|
| | First color filter | | | Second color filter | | |
| | Polyimide, Blue | | | Acrylic, Green | | |
| | | Front | 30° | | Front | 30° |
| | | chromaticity | chromaticity | | chromaticity | chromaticity |
| Example 1 | CIE(x, y) | 0.13, 0.14 | 0.13, 0.14 | CIE(x, y) | 0.25, 0.62 | 0.25, 0.62 |
| | U′, V′ | 0.11, 0.29 | 0.12, 0.28 | U′, V′ | 0.1, 0.56 | 0.10, 0.56 |
| | ΔU′V′ with respect to | | 0.007 | ΔU′V′ with respect to | | 0.002 |
| | front side | | | front side | | |
| | Acrylic, Blue | | | Acrylic, Green | | |
| | | Front | 30° | | Front | 30° |
| | | chromaticity | chromaticity | | chromaticity | chromaticity |
| Comparative | CIE(x, y) | 0.13, 0.14 | 0.13, 0.14 | CIE(x, y) | 0.25, 0.62 | 0.25, 0.54 |
| Example 1 | U′, V′ | 0.11, 0.29 | 0.12, 0.28 | U′, V′ | 0.1, 0.56 | 0.11, 0.54 |

| | | | |
|---|---|---|---|
| ΔU′V′ with respect to | 0.007 | ΔU′V′ with respect to | 0.023 |
| front side | | front side | |

TABLE 6

| | Type 5 | | | | | |
|---|---|---|---|---|---|---|
| | First color filter | | | Second color filter | | |
| | Polyimide, Red | | | Acrylic, Blue | | |
| | | Front | 30° | | Front | 30° |
| | | chromaticity | chromaticity | | chromaticity | chromaticity |
| | CIE(x, y) | 0.65, 0.33 | 0.66, 0.33 | CIE(x, y) | 0.13, 0.14 | 0.13, 0.14 |
| Example 1 | U′, V′ | 0.46, 0.52 | 0.47, 0.52 | U′, V′ | 0.11, 0.29 | 0.12, 0.28 |
| | ΔU′V′ with respect to | | 0.005 | ΔU′V′ with respect | | 0.007 |
| | front side | | | to front side | | |
| | Acrylic, Red | | | Acrylic, Blue | | |
| | | Front | 30° | | Front | 30° |
| | | chromaticity | chromaticity | | chromaticity | chromaticity |
| Comparative | CIE(x, y) | 0.65, 0.33 | 0.66, 0.33 | CIE(x, y) | 0.13, 0.14 | 0.26, 0.24 |
| Example 1 | U′, V′ | 0.46, 0.52 | 0.47, 0.52 | U′, V′ | 0.11, 0.29 | 0.19, 0.40 |

| | | | |
|---|---|---|---|
| ΔU′V′ with respect to | 0.005 | ΔU′V′ with respect to | 0.134 |
| front side | | front side | |

TABLE 7

| | Type 6 | | | | | |
|---|---|---|---|---|---|---|
| | First color filter | | | Second color filter | | |
| | Polyimide, Green | | | Acrylic, Blue | | |
| | | Front | 30° | | Front | 30° |
| | | chromaticity | chromaticity | | chromaticity | chromaticity |
| Example 1 | CIE(x, y) | 0.25, 0.62 | 0.25, 0.62 | CIE(x, y) | 0.13, 0.14 | 0.13, 0.14 |
| | U′, V′ | 0.1, 0.56 | 0.10, 0.56 | U′, V′ | 0.11, 0.29 | 0.12, 0.28 |
| | ΔU′V′ with respect to | | 0.002 | ΔU′V′ with respect to | | 0.007 |
| | front side | | | front side | | |
| | Acrylic, Green | | | Acrylic, Blue | | |
| | | Front | 30° | | Front | 30° |
| | | chromaticity | chromaticity | | chromaticity | chromaticity |
| Comparative | CIE(x, y) | 0.25, 0.62 | 0.25, 0.62 | CIE(x, y) | 0.13, 0.14 | 0.21, 0.30 |
| Example 1 | U′, V′ | 0.1, 0.56 | 0.10, 0.56 | U′, V′ | 0.11, 0.29 | 0.13, 0.44 |

| | | | |
|---|---|---|---|
| ΔU′V′ with respect to | 0.002 | ΔU′V′ with respect to | 0.148 |
| front side | | front side | |

As is apparent from Tables 2 to 7, it was found that, in the display apparatus of Example 1, ΔU′V′ as an index of color shift was suppressed as compared to the display apparatus of Comparative Example 1.

The display apparatus of the present invention can be used for mobile applications in which satisfactory viewing angle characteristics are required, for example, for a rear-side monitor of a digital camera and a mobile phone display. Further, the display apparatus of the present invention can be combined with a zooming optical system to be effectively used as a head mounted display or an EVF for a digital camera.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2012-011947, filed Jan. 24, 2012, and No. 2012-241716, filed Nov. 1, 2012 which are hereby incorporated by reference herein in their entirety.

What is claimed is:

1. A display apparatus comprising:
a substrate;
a first organic light emitting element;
a second organic light emitting element;
a first color filter provided in a region corresponding to the first organic light emitting element; and
a second color filter provided in a region corresponding to the second organic light emitting element, for transmitting a color different from a color transmitted by the first color filter,
wherein the first color filter has a refractive index larger than a refractive index of the second color filter,
wherein the first color filter and the second color filter are in contact with each other, and
wherein, in a cross section taken along a direction perpendicular to the substrate, at a part at which the first color filter and the second color filter are in contact with each other, the first color filter has an angle between a side surface thereof and the substrate, which is more than 90 degrees, and the second color filter has an angle between a side surface thereof and the substrate, which is less than 90 degrees.

2. The display apparatus according to claim 1,
wherein the angle between the side surface of the first color filter and the substrate is 100 degrees or more and 120 degrees or less, and
wherein the angle between the side surface of the second color filter and the substrate is 60 degrees or more and 80 degrees or less.

3. The display apparatus according to claim 1, wherein a ratio of the refractive index of the first color filter with respect to the refractive index of the second color filter is 1.001 or more and 1.300 or less.

4. The display apparatus according to claim 1, wherein a ratio of the refractive index of the first color filter with respect to the refractive index of the second color filter is 1.010 or more and 1.300 or less.

5. The display apparatus according to claim 1, wherein a ratio of the refractive index of the first color filter with respect to the refractive index of the second color filter is 1.050 or more and 1.300 or less.

6. The display apparatus according to claim 1, wherein the first color filter contains one of a polyimide resin and a novolac resin.

7. The display apparatus according to claim 1, wherein the second color filter contains an acrylic resin.

8. The display apparatus according to claim 1, further comprising:
a third organic light emitting element; and
a third color filter provided in a region corresponding to the third organic light emitting element,
wherein the third color filter has a refractive index smaller than the refractive index of the first color filter and larger than the refractive index of the second color filter,
wherein the third color filter is in contact with the first color filter and the second color filter,
wherein, in the cross section, at a part at which the first color filter and the third color filter are in contact with each other, the first color filter has an angle between the side surface thereof and the substrate, which is more than 90 degrees, and the third color filter has an angle between a side surface thereof and the substrate, which is less than 90 degrees, and
wherein, in the cross section, at a part at which the second color filter and the third color filter are in contact with each other, the third color filter has an angle between a side surface thereof and the substrate, which is more than 90 degrees, and the second color filter has an angle between the side surface thereof and the substrate, which is less than 90 degrees.

9. The display apparatus according to claim 8,
wherein the angle between the side surface of the first color filter and the substrate at the part at which the first color filter and the third color filter are in contact with each other, and the angle between the side surface of the third color filter and the substrate at the part at which the second color filter and the third color filter are in contact with each other are both 100 degrees or more and 120 degrees or less, and
wherein the angle between the side surface of the third color filter and the substrate at the part at which the first color filter and the third color filter are in contact with each other, and the angle between the side surface of the second color filter and the substrate at the part at which the second color filter and the third color filter are in contact with each other are both 60 degrees or more and 80 degrees or less.

10. The display apparatus according to claim 8, wherein a ratio of the first color filter with respect to the refractive index of the second color filter is 1.001 or more and 1.300 or less.

11. The display apparatus according to claim 8, wherein a ratio of the first color filter with respect to the refractive index of the second color filter is 1.010 or more and 1.300 or less.

12. The display apparatus according to claim 8, wherein a ratio of the first color filter with respect to the refractive index of the second color filter is 1.050 or more and 1.300 or less.

13. The display apparatus according to claim 8, wherein a ratio of the third color filter with respect to the refractive index of the second color filter is 1.001 or more and 1.150 or less.

14. The display apparatus according to claim 8, wherein a ratio of the third color filter with respect to the refractive index of the second color filter is 1.010 or more and 1.150 or less.

15. The display apparatus according to claim 8, wherein a ratio of the third color filter with respect to the refractive index of the second color filter is 1.050 or more and 1.150 or less.

16. The display apparatus according to claim 8, wherein a ratio of the first color filter with respect to the refractive index of the third color filter is 1.001 or more and 1.150 or less.

17. The display apparatus according to claim 8, wherein a ratio of the refractive index of the first color filter with respect to the refractive index of the third color filter is 1.010 or more and 1.150 or less.

18. The display apparatus according to claim 8, wherein a ratio of the first color filter with respect to the refractive index of the third color filter is 1.050 or more and 1.150 or less.
